(19) United States
(12) Patent Application Publication
(10) Pub. No.: US 2007/0176531 A1
(43) Pub. Date: Aug. 2, 2007

(54) Phoshor and light-emitting diode

(76) Inventors: Hiroyuki Kinoshita, Kyoto-Shi (JP); Hiromu Shiomi, Kyoto-Shi (JP); Makolo Sasaki, Kyoto-Shi (JP); Toshihiko Hayashi, Kyoto-Shi (JP); Hiroshi Amano, Nagoya-Shi (JP); Satoshi Kamiyama, Nagoya-shi (JP); Motoaki Twaya, Nagoya-shi (JP); Isamu Akasaki, Nagoya-shi (JP)

Correspondence Address: BIRCH STEWART KOLASCH & BIRCH, PO BOX 747, FALLS CHURCH, VA, 22040-0747, US

(21) Appl. No.: 10/594,010

(22) PCT Filed: Mar. 22, 2005
(86) PCT No.: PCT/JP05/05143

§ 371 Date: Sep. 25, 2006

(30) Foreign Application Priority Data
Mar. 24, 2004 (JP) 2004-087110

(51) Int. Cl. H01J 1/62; H01J 63/04

(52) U.S. Cl. 313/486; 313/512

(57) ABSTRACT

Disclosed is a phosphor which is excited by a long wavelength light source in the ultraviolet region or blue-violet visible region and mainly emits light in violet-blue-yellow-red visible region. Also disclosed is a low-cost light-emitting diode which is easily mounted and excellent in color rendering properties. This light-emitting diode does not have much color change due to radiation angle. A phosphor composed of SiC is characterized in that it is excited by an outside light source for emitting light and doped with N and at least one of B and Al.

### TECHNICAL FIELD

The present invention relates to a phosphor of SiC excited by an electromagnetic wave such as an electron beam, an X-ray, an ultraviolet ray or a blue-violet visible ray for emitting light and a method of manufacturing the same as well as a substrate and powder for a semiconductor consisting of such a phosphor. The present invention further relates to a light-emitting diode comprising a group III nitride semiconductor expected for future popularization as a new solid illuminating device.

### BACKGROUND ART

A PDP panel emitting light by exciting a phosphor with a vacuum ultraviolet ray radiated by rare gas discharge is actively developed. The PDP panel is formed by a large number of display cells arranged in the form of a matrix, and each display cell is provided with an ignition electrode. The inner part thereof is coated with a phosphor, to seal rare gas such as He—Xe or Ne−Xe. When a voltage is applied to the ignition electrode, a vacuum ultraviolet ray is radiated to excite the phosphor, thereby emitting visible light.

When a discharge tube filled with a gas mixture of mercury and argon gas starts discharging in a fluorescent lamp, electrons present in a discharge space are accelerated by an electric field to stray toward an anode. The electrons excite mercury atoms in the fluorescent lamp tube in the meantime, for emitting visible light with an ultraviolet ray of 253.7 nm in wavelength discharged from the excited mercury atoms.

A phosphor (hereinafter referred to as “ultraviolet-excited phosphor”) excited by an ultraviolet ray for emitting light is widely applied to a fluorescent lamp, a high-pressure mercury lamp, decoration with a fluorescent wallplate or a fluorescent tile used indoors/outdoors or the like in practice. The fluorescent wallplate or tile is excited with an ultraviolet ray having a long wavelength of about 365 nm in particular, for emitting bright light of various colors.

A device excited by light emitted from a semiconductor is also known. In this device, a load on the semiconductor is reduced as the wavelength of the light from the semiconductor is increased. Therefore, the wavelength of the excitation light is preferably at least 360 nm, more preferably at least 380 nm, particularly preferably at least 400 nm.

In general, phosphors excited by a long-wavelength ultraviolet ray include an Eu-activated alkaline earth halophosphate phosphor, an Eu-activated alkaline earth aluminate phosphor and an Eu-activated LnO phosphor all emitting blue light. The phosphors further include a Zn₂GeO₄:Mn phosphor etc. emitting green light, while a YAG:Ce (cerium-added yttrium aluminum garnet) phosphor emitting yellow light and a Y₂O₂S:Eu phosphor as well as a YVO₄:Eu phosphor both emitting red light are put into practice.

Following diversification and high functionalization of display, however, color multiplication and brightening of luminescent colors as well as improvement in durability and improvement in weather resistance are required. Further, a phosphor employing a group II-VI semiconductor such as ZnSe or ZnO is actively studied (refer to Japanese Patent Laying-Open No. 2001-228809 (Patent Document 1)).

On the other hand, a phosphor prepared by adding a rare earth element such as Yb or Er to a matrix of SiC for emitting infrared light of at least 900 nm through excitation of the rare earth element itself is known (refer to Japanese Patent Laying-Open No. 10-270807 (Patent Document 2)). This phosphor, having the matrix of SiC, mainly emits light from the rare earth element in principle, and employs the same mechanism as light emission through addition of a rare earth element to a matrix of an oxide. An SiC crystal can be prepared by an improved Rayleigh method performing sublimation recrystallization on a seed crystal of single-crystalline SiC (refer to Y. M. Tairov and V. F. Tsvctkov, Journal of Crystal Growth (1981), Vol. 52, pp. 146 to 150 (Non-Patent Document 1)).

A crystal growth method for a nitride semiconductor has rapidly progressed in recent years, and blue and green light-emitting diodes of high brightness employing nitride semiconductors are put into practice. A generally present red light-emitting diode and these blue and green light-emitting diodes are combined with each other for completely implementing the three primary colors of light, so that a full-color display can also be implemented. In other words, white light can also be obtained when all of the three primary colors of light are mixed with each other, and application to a device for white illumination is also possible.

Various structures have been proposed as white light sources employing light-emitting diodes, and are partially put into practice. FIG. 9 shows an exemplary white light source employing light-emitting diodes. In this white light source, light-emitting diodes of the three primary colors, i.e., a red light-emitting diode 911, a green light-emitting diode 912 and a blue light-emitting diode 913 are formed on a metal layer 903 of a conductive heat sink 902 and fixed onto a stem 905 with epoxy resin 908, as shown in FIG. 9.

With this white light source, not only white but also full colors can be displayed by connecting lead wires connected to the respective light-emitting diodes to individual terminals and independently controlling currents fed thereto, with high energy conversion efficiency. However, this white light source is unsuitable for a simple illumination device since the device and a driving circuit are complicated to require a high cost.

FIG. 10 shows another exemplary white light source employing a light-emitting diode. In this white light source, a blue light-emitting diode 101 is formed on a metal layer 103 of a conductive heat sink 102 while a yellow phosphor layer 104 of a YAG-based material is formed on blue light-emitting diode 101 and fixed onto a stem 105 with epoxy resin 108, as shown in FIG. 10.

In this white light source, YAG-based yellow phosphor layer 104 absorbs part of light having a peak wavelength of about 450 nm discharged from blue light-emitting diode 101 and converts the same to yellow fluorescence having a wavelength of about 570 nm. Therefore, the device discharges both of blue light transmitted through YAG-based yellow phosphor layer 104 and yellow light emitted by YAG-based yellow phosphor layer 104. Yellow is complementary to blue, whereby white light is obtained by mixing the yellow light and the blue light with each other.

The white light source shown in FIG. 10, constituted of single light-emitting diode 101, can be prepared at a relatively low cost. Further, the highest luminous efficiency is implemented at present, while that having brightness efficiency of about 701 m/W is implemented at a study level, equivalently to an existing fluorescent lamp.
Patent Document 1: Japanese Patent Laying-Open No. 2001-228809
Patent Document 2: Japanese Patent Laying-Open No. 10-270807
Non-Patent Document 1: Y. M. Tairov and V. F. Tsvctkov, Journal of Crystal Growth (1981), Vol. 52, pp. 146 to 150

### DISCLOSURE OF THE INVENTION

### Problems to be Solved by the Invention

In a conventional phosphor, having a matrix of an oxide, excited by a long-wavelength light source, luminous efficiency of fluorescence is deteriorated as the wavelength of excitation light is increased, and luminous efficiency of red light is particularly inferior. An oxide has an extremely wide band gap in general, and hence excitation of the oxide itself cannot be utilized in excitation by the long-wavelength light source. While excitation of a rare earth element itself is therefore utilized, luminous efficiency of fluorescence is extremely low and not improved when a material to which a rare earth element is added is excited with a long wavelength.

A phosphor employing a group II-VI semiconductor so easily forms a mixed crystal or a solid solution that a technique such as band engineering can also be employed and luminous efficiency is extremely high. However, both of the group II and the group VI have high electronegativity, and hence ionicity of a group II-VI semiconductor crystal is so increased as to easily cause aged deterioration.

In a method of adding a rare earth element to SiC for utilizing emission of infrared light through excitation of the rare earth element, crystallinity of SiC is extremely deteriorated through addition of the rare earth element since the rare earth element has a large atomic radius while the lattice constant of SiC is extremely small. Therefore, the quantity of the added rare earth element is so limited that luminous intensity cannot be increased.

While donor-acceptor (donor acceptor) (hereinafter referred to as “DA”) pair luminescence implemented by simultaneously adding N and B to SiC so that N functions as a donor and B functions as an acceptor has a peak at a wavelength of about 650 nm, luminous intensity is so small that the same cannot be utilized as a phosphor.

As to the white light source employing the light-emitting diode(s), the example shown in FIG. 9, for example, has such problems to be solved that the driving circuit and the device are so complicated that the same are hard to mount and the yield is low and color heterogeneity results from a radiation angle of light.

The example shown in FIG. 10 converts part of the blue light emitted from blue light-emitting diode 101 to yellow light by exciting yellow phosphor layer 104 for obtaining white light by discharging both of the blue light and the yellow light. In this case, the color shade is changed unless the intensity ratio between the blue light and the yellow light is properly set. Therefore, the thickness and a phosphor concentration of yellow phosphor layer 104 formed on blue light-emitting diode 101 must be properly and homogeneously adjusted. Thus, a technique of homogeneously mixing yellow phosphor powder into a binder of resin and applying the mixture with a homogeneous thickness is necessary.

Also when phosphor layer 104 is homogeneous, the path length of light emitted from blue light-emitting diode 101 to pass through the phosphor layer varies with the angle of emission. Therefore, the color shade of the white light inevitably varies with the angle of emission. Further, the combination of blue light-emitting diode 101 and yellow phosphor layer 104 shown in FIG. 10 is inferior in color rendering, the property important for serving as an illumination light source, and has low reproducibility for red light due to an extremely small quantity of a red component.

An object of the present invention is to provide a phosphor excited by a long-wavelength light source in the ultraviolet region or the blue-violet visible region for mainly emitting light in a violet-blue-yellow-red visible region. Another object of the present invention is to provide a phosphor efficiently emitting fluorescence having excellent characteristics with primary light from a light source such as a mercury discharge tube, a high-pressure mercury lamp or an LED (laser emitting diode), a vacuum ultraviolet ray resulting from discharge of a PDP panel or an electron beam.

Still another object of the present invention is to provide a low-cost light-emitting diode easy to mount and excellent in color rendering. A further object of the present invention is to provide a light-emitting diode having small change in color shade resulting from an angle of radiation.

### MEANS FOR SOLVING THE PROBLEMS

A phosphor of SiC according to the present invention is excited by an external light source for emitting light, and doped with N and at least one of B and Al. In such a phosphor, both of the doping concentration with at least one of B and Al and the doping concentration with N are preferably 10¹⁵/cm³ to 10²⁰/cm³, more preferably 10¹⁶/cm³ to 10²⁰/cm³.

The phosphor of SiC according to the present invention includes that emitting fluorescence having a wavelength of 500 nm to 750 nm with a peak wavelength in the range of 500 nm to 650 nm. Such SiC is preferably doped with N and B, the concentration of either N or B is preferably 10¹⁵/cm³ to 10¹⁸/cm³, and the concentration of either B or N is preferably 10¹⁶/cm³ to 10¹⁹/cm³.

Further, the phosphor of SiC according to the present invention includes that emitting fluorescence having a wavelength of 400 nm to 750 nm with a peak wavelength in the range of 400 nm to 550 nm. Such SiC is preferably doped with N and Al, the concentration of either N or Al is preferably 10¹⁵/cm³ to 10⁸/cm³, and the concentration of either Al or N is preferably 10¹⁶/cm³ to 10¹⁹/cm³.

A method of manufacturing a phosphor of SiC according to the present invention is a method of manufacturing a phosphor of SiC excited by an external light source for emitting fluorescence having a wavelength of 500 nm to 750 nm with a peak wavelength in the range of 500 nm to 650 nm and doped with N and B so that the concentration of either N or B is 10¹⁵/cm³ to 10¹⁸/cm³ and the concentration of either B or N is 10¹⁶/cm³ to 10¹⁹/cm³ by forming an SiC crystal by sublimation recrystallization with a B source of LaB₆, B₄C, TaB₂, NbB₂, ZrB₂, HfB₂, BN or carbon containing B, according to a certain aspect of the present invention.

According to another aspect, the present invention is characterized in that a B source of simple B, LaB₆, B₄C, TaB₂, NbB₂, ZrB₂, HfB₂ or BN is thermally diffused into SiC under a vacuum or an inert gas atmosphere at a temperature of at least 1500° C.

A substrate for a semiconductor according to the present invention consists of a 6H—SiC single-crystalline phosphor excited by an external light source for emitting light and doped with N and at least one of B and Al. Such a semiconductor substrate includes that consisting of a 6H—SiC single-crystalline phosphor doped with N and B for emitting fluorescence having a wavelength of 500 nm to 750 nm with a peak wavelength in the range of 500 nm to 650 nm. Further, this substrate includes a semiconductor substrate consisting of a 6H—SiC single-crystalline phosphor doped with N and Al for emitting fluorescence having a wavelength of 400 nm to 750 nm with a peak wavelength in the range of 400 nm to 550 nm.

A method of manufacturing a substrate for a semiconductor according to the present invention is a method of manufacturing a substrate for a semiconductor consisting of a 6H—SiC single-crystalline phosphor excited by an external light source for emitting fluorescence having a wavelength of 500 nm to 750 with a peak wavelength in the range of 500 nm to 650 nm and doped with N and B so that the concentration of either N or B is 10¹⁵/cm³ to 10¹⁸/cm³ and the concentration of either B or N is 10¹⁶/cm³ to 10¹⁹/cm³ comprising the steps of thermally diffusing a B source of simple B, LaB₆, B₄C, TaB₂, NbB₂, ZrB₂, HfB₂ or BN into SiC under a vacuum or an inert gas atmosphere at a temperature of at least 1500° C. and removing a surface layer, according to a certain aspect of the present invention.

According to another aspect of the present invention, an SiC crystal is formed by such sublimation recrystallization that atmosphere gas in crystal growth contains N₂ gas of 1% to 30% in gas partial pressure, and raw material SiC contains 0.05 mol % to 15 mol % of a B source.

Powder for a semiconductor according to the present invention consists of a 6H—SiC single-crystalline phosphor excited by an external light source for emitting fluorescence having a wavelength of 500 nm to 750 nm with a peak wavelength in the range of 500 nm to 650 nm, having a particle diameter of 2 μm to 10 μm and a central particle diameter of 3 μm to 6 μm.

A light-emitting diode according to the present invention comprises a substrate for a semiconductor consisting of a 6H—SiC single-crystalline phosphor doped with N and at least one of B and Al and a light-emitting device of a nitride semiconductor formed on the substrate, according to a certain aspect of the present invention.

According to another aspect of the present invention, the light-emitting diode has at least one or two layers consisting of a 6H—SiC single-crystalline phosphor doped with N and at least one of B and Al on a substrate of SiC for a semiconductor, and comprises a light-emitting device of a nitride semiconductor on the 6H—SiC single-crystalline phosphor layer(s). In such a light-emitting diode, the emission wavelength of the light-emitting device of a nitride semiconductor is not more than 408 nm.

In such a light-emitting diode, both of the doping concentration with at least one of B and Al and the doping concentration with N in the 6H—SiC single-crystalline phosphor are preferably 10¹⁶/cm³ to 10¹⁹/cm³, more preferably 10¹⁷/cm³ to 10¹⁹/cm³.

### EFFECTS OF THE INVENTION

According to the present invention, it is possible to provide a phosphor capable of controlling an impurity concentration in SiC for efficiently emitting light in a violet-blue-yellow-red visible region through excitation by long-wavelength light or an electron beam in the ultraviolet region or the blue-violet visible region.

According to the present invention, further, it is possible to provide a white light source allowing easy adjustment of color rendering and easily mountable due to a single light-emitting diode at a low cost. This white light source generates white light therein, whereby change of color shade resulting from an angle of radiation is negligibly small, and the light source is excellent in luminous efficiency.

### BRIEF DESCRIPTION OF THE DRAWINGS

FIG. 1 is a model diagram showing an exemplary single crystal growth apparatus employed for a method of manufacturing a phosphor of SiC according to the present invention.

FIG. 2 is a model diagram for illustrating the principle of an improved Rayleigh method used in the manufacturing method according to the present invention.

FIG. 3 illustrates emission characteristics of the phosphor of SiC according to the present invention.

FIG. 4 is a model diagram showing the structure of a light-emitting diode according to the present invention.

FIG. 5 is a model diagram showing a mounted state of the light-emitting diode according to the present invention.

FIG. 6 illustrates emission characteristics of another phosphor of SiC according to the present invention.

FIG. 7 is a model diagram showing the structure of another light-emitting diode according to the present invention.

FIG. 8 is a model diagram showing a mounted state of the light-emitting diode according to the present invention.

FIG. 9 is a model diagram showing a mounted state of conventional light-emitting diodes.

FIG. 10 is a model diagram showing a mounted state of a conventional light-emitting diode.

### DESCRIPTION OF REFERENCE NUMERALS

1 substrate, 2 raw material, 3 crucible, 4 lid, 5 quartz tube, 6 support rod, 7 heat shield, 8 work coil, 9 introduction tube, 401 SiC substrate, 402 first impurity-added SiC layer, 403 second impurity-added SiC layer, 404 AlGaN buffer layer, 405 n-GaN first contact layer, 406 n-AlGaN first cladding layer, 407 GaInN/GaN multiple quantum well active layer, 408 p-AlGaN electron blocking layer, 409 p-AlGaN second cladding layer, 410 p-GaN second contact layer, 411 p electrode, 412 n electrode.

### BEST MODES FOR CARRYING OUT THE INVENTION

(Phosphor of SiC)

A phosphor of SiC according to the present invention is doped with N and at least one of B and Al. Such a phosphor of SiC is excited by an external light source such as a long-wavelength light source or an electron beam in the ultraviolet region or the blue-violet visible region, to mainly emit light in a violet-blue-yellow-red visible region.

For example, a phosphor of SiC doped with B and N is excited by an external light source for emitting fluorescence having a wavelength of 500 nm to 750 nm, with a peak wavelength in the range of 500 nm to 650 nm. A phosphor of SiC doped with Al and N emits fluorescence having a wavelength of 400 nm to 750 nm, with a peak wavelength in the range of 400 nm to 550 nm. Further, a phosphor of SiC doped with Al, B and N emits fluorescence of 400 nm to 750 nm, with a peak wavelength in the range of 400 nm to 650 nm.

In order to improve luminous efficiency of fluorescence, state density of an impurity level sufficient for accepting electron-hole pairs relaxed from a band edge of SiC is necessary. In this regard, both of the impurity concentration with at least one of B and Al and the impurity concentration with N are preferably 10¹⁵/cm³, more preferably at least 10¹⁶/cm³, particularly preferably at least 10¹⁸/cm³. On the other hand, the impurity concentrations are preferably not more than 10²⁰/cm³, since luminous efficiency of fluorescence tends to lower if the impurity concentrations are excessively high.

When the phosphor is doped with N and B, the concentration of either N or B is preferably 10¹⁵/cm³ to 10¹⁸/cm³, and the concentration of either B or N is preferably 10¹⁶/cm³ to 10¹⁹/cm³. Also when the phosphor is doped with N and Al, the concentration of either N or Al is preferably 10¹⁵/cm³ to 10¹⁸/cm³ and the concentration of either Al or N is preferably 10¹⁶/cm³ to 10¹⁹/cm³. Throughout the specification, emitted light is expressed by a numerical value obtained by measuring light emitted upon incidence of a beam (violet) having a wavelength of 404.7 nm with PHOTOLUMINOR-S by Horiba, Ltd. The concentration of N, Al or B is expressed by a numerical value measured with SIMS (secondary ion mass spectroscope).

An external light source utilizable in the present invention is a light source radiating visible light such as a blue-violet ray, an ultraviolet ray, an X-ray or an electron beam, while visible light such as a blue-violet ray or an ultraviolet ray having a wavelength of 100 nm to 500 nm tending to emit fluorescence having high luminous intensity is particularly preferable. An SiC semiconductor has a wide band gap of about 3 eV, and can create various orders in the band through addition of an impurity. In particular, 6H—SiC exhibiting a wavelength of 408 nm on a band edge can be excited with a wavelength shorter than this wavelength of the band edge through the band gap of SiC, and light of a relatively long wavelength can be utilized as an excitation source.

The inventors have made deep study to find that luminous intensity is sufficiently increased when a 6H—SiC polytype crystal is doped with N serving as a donor under a condition sufficiently activating B serving as an acceptor so that the concentration of the DA pair is 10¹⁵/cm³ to 10¹⁸/cm³. The lower limit of the concentration of the DA pair is more preferably at least 5×10¹⁵/cm³, particularly preferably 10¹⁶/cm³, further preferably at least 2×10¹⁶/cm³, in order to improve the luminous intensity. On the other hand, the upper limit is more preferably not more than 8×10¹⁷/cm³, in order to improve the luminous intensity similarly to the above.

When the concentration of the DA pair is in this range, the lower limit of the concentration of either B or N is more preferably at least 10¹⁶/cm³, particularly preferably at least 5×10¹⁶/cm³, in order to attain excellent light emission. On the other hand, the upper limit is more preferably not more than 10¹⁹/cm³, particularly preferably not more than 5×10¹⁸/cm³, in order to attain excellent light emission similarly to the above.

A phosphor of SiC containing B and N with concentrations in this range emits excellent red-yellow fluorescence exhibiting a broad spectrum, as illustrated in FIG. 3. In other words, the phosphor of SiC according to the present invention emits fluorescence having a wavelength of 500 nm to 750 nm, with high luminous intensity in the wavelength range of 550 nm to 680 nm. That having a peak wavelength in the range of 500 nm to 650 nm or that having a peak wavelength in the range of 570 mm to 630 nm is preferable. The emission wavelength and relative intensity thereof vary with the doping concentrations of B and N in SiC.

Also as to a DA pair of Al and N, the inventors have similarly found concentration conditions increasing luminous intensity. In other words, they have found that luminous intensity is sufficiently increased when a 6H—SiC polytype crystal is doped with N serving as a donor under a condition sufficiently activating Al serving as an acceptor so that the concentration of the DA pair is 10¹⁵/cm³ to 10¹⁸/cm³. The lower limit of the concentration of the DA pair is more preferably at least 5×10¹⁵/cm³, particularly preferably 10¹⁶/cm³, further preferably at least 2×10¹⁶/cm³, in order to improve the luminous intensity. On the other hand, the upper limit is more preferably not more than 8×10¹⁷/cm³, in order to improve the luminous intensity similarly to the above.

When the concentration of the DA pair is in this range, the lower limit of the concentration of either Al or N is more preferably at least 10¹⁶/cm³, particularly preferably at least 5×10¹⁶/cm³, in order to attain excellent light emission. On the other hand, the upper limit is more preferably not more than 10¹⁹/cm³, particularly preferably not more than 5×10¹⁸/cm³, in order to attain excellent light emission similarly to the above.

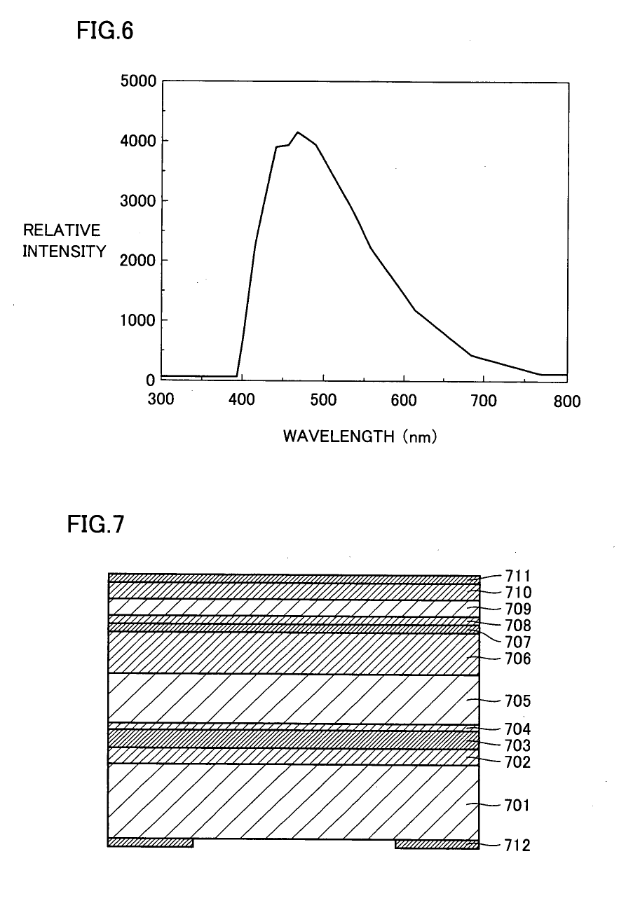

A phosphor of SiC containing Al and N with concentrations in this range emits broad blue fluorescence exhibiting a broad spectrum, as illustrated in FIG. 6. In other words, the phosphor of SiC according to the present invention emits fluorescence having a wavelength of 400 nm to 750 nm, with high luminous intensity in the wavelength range of 400 nm to 550 nm. That having a peak wavelength in the range of 400 nm to 550 nm or that having a peak wavelength in the range of 410 nm to 470 nm is preferable. The emission wavelength and relative intensity thereof vary with the doping concentrations of Al and N in SiC.

(Method of Manufacturing Phosphor of SiC)

A method of manufacturing a phosphor of SiC according to the present invention is characterized in formation of an SiC crystal by sublimation recrystallization with a B source of LaB₆, B₄C, TaB₂, NbB₂, ZrB₂, HfB₂, BN or carbon containing B. According to this method, SiC is doped with N and B, the doping concentrations can be so adjusted that the concentration of either N or B is 10¹⁵/cm³ to 10¹⁸/cm³ and the concentration of either B or N is 10¹⁶/cm³ to 10¹⁹/cm³, and a phosphor of SiC excited by an external light source for emitting fluorescence having a wavelength of 500 nm to 750 nm with a peak wavelength in the range of 500 nm to 650 nm can be manufactured.

Such concentration adjustment can be attained by positively adding N and B during crystal growth of SiC. While an SiC crystal can be prepared by an improved Rayleigh method, a nucleation process of the crystal can be controlled according to this method employing a seed crystal, and the growth rate of the crystal etc. can be controlled with excellent reproducibility by controlling an atmosphere to a pressure of about 100 Pa to 15 kPa with inert gas.

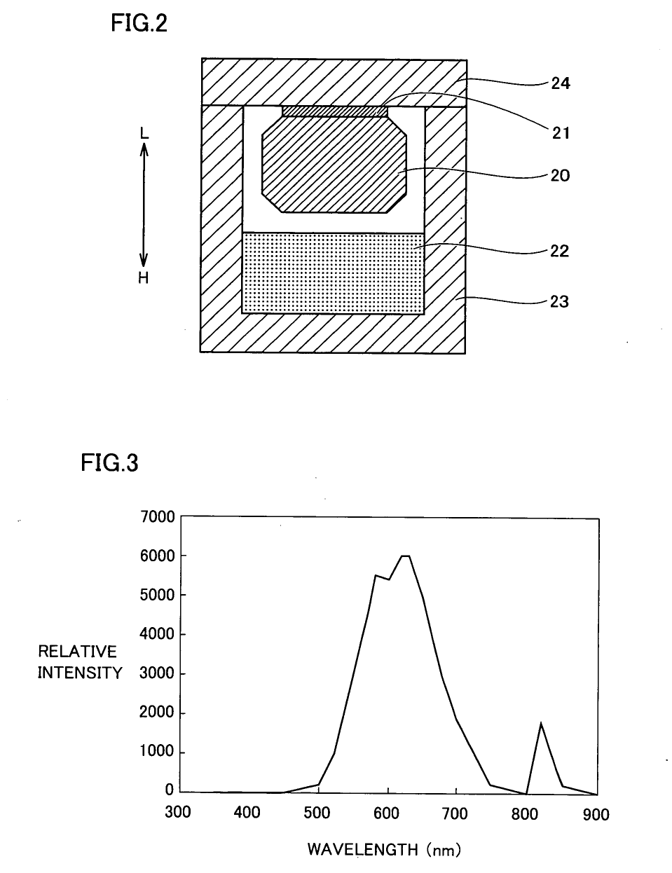

According to the improved Rayleigh method, single-crystalline SiC serving as a seed crystal 21 is mounted on a lid 24 of a crucible 23, while SiC crystal powder serving as a raw material 22 for sublimation recrystallization is added to crucible 23 of graphite and heated in an atmosphere of inert gas such as Ar under a pressure of 133 Pa to 13.3 kPa to a temperature of 2000° C. to 2400° C., as shown in FIG. 2. In heating, the temperature gradient is so set that the SiC crystalline powder serving as raw material 22 is slightly at a high temperature (H) and seed crystal 21 is slightly at a low temperature (L), as shown by arrows in FIG. 2. Raw material 22 is diffused and transported toward seed crystal 21 due to a concentration gradient formed on the basis of the temperature gradient after sublimation. Growth of an SiC single crystal 20 is implemented by recrystallization of raw material gas, reaching seed crystal 21, on the seed crystal.

The doping concentration in the SiC crystal can be controlled through addition of impurity gas into the atmosphere gas and addition of an impurity element or a compound thereof to the raw material powder in crystal growth. In particular, sublimation recrystallization with addition of N₂ gas is preferable in a point that the N concentration of at least 5×10¹⁸/cm³ is easy to control. Further, the conditions are preferably so set as to positively add N and stably add B into the crystal, in order to stabilize concentration control of the DA pair of not more than 1×10¹⁸/cm³, increase reproducibility and improve luminous intensity.

For example, a phosphor of SiC having an N concentration of 10¹⁵/cm³ to 10¹⁸/cm³ can be manufactured by setting the partial pressure of N₂ gas in the atmosphere gas in crystal growth to 1% to 30%. In this case, the partial pressure of the N₂ gas is preferably 5% to 10%, in order to increase luminous intensity of the fluorescence.

While simple B (metallic boron) may be mixed into the raw material in order to add B, the B concentration is so disadvantageously instable according to this method that the B concentration is high in the initial stage of crystallization and reduced in the latter half of crystallization. Therefore, M is preferably added in the form of a B compound expressed as MB₂ as a metal containing at least any one of Ta, Nb, Zr and Hf, so that the B concentration does not excessively change during crystal growth. Further, B may be preferably added as LaB₆ or B₄C, so that change of the B concentration can also be suppressed. B can be easily stably added in a concentration of 10¹⁷/cm³ to 10¹⁸/cm³ according to this method.

Since carbon is easily impregnated with simple B (metallic boron) and gradually discharges B also at a sublimation recrystallization temperature of at least 2000° C., a method of performing sublimation recrystallization while employing carbon containing simple B as a B source is excellent as a method of forming an SiC crystal to which B is added. When carbon impregnated with simple B at a high temperature of at least 1500° C. is previously added to the raw material, the B concentration in the crystal can advantageously be kept substantially unchanged.

Both of N and B can be simultaneously added into SiC without adding N₂ gas by adding powdery or solid BN into the raw material of SiC and performing sublimation recrystallization while keeping a relatively low temperature of about 2000° C. In this case, the quantity of added B tends to relatively lower, and hence B is preferably positively added through any of the aforementioned method. A phosphor of SiC having a DA pair concentration of 1×10¹⁸/cm³ to 8×10¹⁸/cm³ can be stably obtained by sublimation recrystallization employing BN.

After sublimation recrystallization, thermal annealing is preferably performed at a temperature of at least 1300° C. for at least one hour, in order to increase luminous intensity of the fluorescence. This is conceivably because B and N mixed in an energetically inactive state are fixed on the position of Si or C and activated to increase the concentration of the DA pair.

While the quantity of the B source varies with other conditions such as the type of the B source, B can be easily stably added to the SiC crystal in a concentration of 10¹⁶/cm³ to 10¹⁹/cm³ by preparing the raw material by adding 0.05 mol % to 15 mol % of the B source to the SiC powder. When MB₂, BN or LaB₆ other than simple B (metallic boron) is blended as the B source in this case, a quantity calculated in terms B contained in the B source is regarded as the quantity of the B source. The quantity of the B source is preferably 2.5 mol % to 5 mol % with respect to the SiC powder, in order to increase luminous intensity of the fluorescence.

Another method of manufacturing a phosphor of SiC according to the present invention is characterized in thermal diffusion of a B source of simple B, LaB₆, B₄C, TaB₂, NbB₂, ZrB₂, HfB₂ or BN into SiC under a vacuum or an inert gas atmosphere at a temperature of at least 1500° C. According to this method, SiC is doped with N and B, the doping concentrations can be so adjusted that the concentration of either N or B is 10¹⁵/cm³ to 10¹⁸/cm³ and the concentration of either B or N is 10¹⁶/cm³ to 10¹⁹/cm³, and a phosphor of SiC excited by an external light source for emitting fluorescence having a wavelength of 500 nm to 750 nm with a peak wavelength in the range of 500 nm to 650 nm can be manufactured.

Concentration adjustment of B and N can also be attained by controlling thermal diffusion conditions. SiC subjected to thermal diffusion can be prepared from that doped with N by about 10¹⁷/cm³ by sublimation recrystallization, for example. Since a B source may react with an SiC crystal to erode the SiC crystal if the B source is brought into direct contact with the SiC crystal in thermal diffusion, the B source is preferably separated from the SiC crystal by about 0.1 mm for thermal diffusion.

In thermal diffusion, inert gas such as Ar gas can be used, and a diffusion layer of B having a thickness of about 3 μm is formed on the surface of the SiC crystal when heated to at least 1500° C., preferably to 1700° C. to 2000° C. and held for three hours to five hours. When an ultraviolet ray having an output of 30 W and a wavelength of 250 nm, for example, is applied thereto, this emits fluorescence confirmable with the naked eye.

A diffusion layer containing B in a high concentration of at least 10¹⁹/cm³ may be formed on the surface of the SiC crystal, depending on the conditions of thermal diffusion. Since an area emitting intense fluorescence is 2 μm to 4 μm from the surface of the SiC crystal, the high-concentration B layer is preferably removed from the surface by a thickness of about 2 μm, in order to increase luminous intensity. For example, it is preferable to form an oxide film by performing heating under an oxidative atmosphere at a temperature of at least 1000° C., preferably at 1200° C. to 1400° C., for two hours to four hours after thermal diffusion and to thereafter remove the surface of the oxide film by chemical treatment with hydrofluoric acid, for example. The surface layer can alternatively be preferably removed by polishing or reactive ion etching (RIE). Further, thermal annealing is preferably performed at a temperature of at least 1300° C. for at least one hour after thermal diffusion similarly to the case of sublimation recrystallization, so that luminous intensity of the fluorescence can be increased.

The aforementioned embodiment illustrates a method of manufacturing a phosphor of SiC having an N concentration of 10¹⁵/cm³ to 10¹⁸/cm³ and a B concentration of 10¹⁶/cm³ to 10¹⁹/cm³. However, the present invention, exhibiting a remarkable effect in a phosphor of SiC having a B and N pair concentration of 10¹⁵/cm³ to 10¹⁸/cm³ and either a B concentration or an N concentration of 10¹⁶/cm³ to 10¹⁹/cm³, also includes a phosphor of SiC having an N concentration of 10¹⁶/cm³ to 10¹⁹/cm³ and a B concentration of 10¹⁵/cm³ to 10¹⁸/cm³ and a method of manufacturing the same.

(Substrate for Semiconductor and Powder)

Each of a substrate for a semiconductor and powder according to the present invention consists of a 6H—SiC single-crystalline phosphor excited by an external light source for emitting light and doped with N and at least one of B and Al.

For example, each of a semiconductor substrate and powder consisting of 6H—SiC single-crystalline phosphor doped with B and N is excited by an external light source for emitting fluorescence having a wavelength of 500 nm to 750 nm with a peak wavelength in the range of 500 nm to 650 nm. Further, each of a semiconductor substrate and powder consisting of a 6H—SiC single-crystalline phosphor doped with Al and N emits fluorescence having a wavelength of 400 nm to 750 nm with a peak wavelength in the range of 400 nm to 550 nm. In addition, each of a semiconductor substrate and powder consisting of a 6H—SiC single-crystalline phosphor doped with Al, B and N emits fluorescence of 400 nm to 750 nm with a peak wavelength in the range of 400 nm to 650 nm.

When the phosphor of SiC according to the present invention is applied to a substrate used for a semiconductor such as a GaN-based compound semiconductor emitting light in the blue-violet region or powder, a 6H—SiC single-crystalline phosphor is excited by blue-violet primary light from the semiconductor for emitting secondary light of a violet-blue-yellow-red visible region in the obtained light-emitting device, whereby excellent white light can be obtained through a mixture of direct light from the semiconductor and the secondary light from the phosphor of SiC or a mixture of the secondary light.

Each of the semiconductor substrate and the powder consisting of the 6H—SiC single-crystalline phosphor doped with B and N can be manufactured by a method comprising the steps of thermally diffusing a B source of simple B, LaB₆, B₄C, TaB₂, NbB₂, ZrB₂, HfB₂ or BN into SiC under a vacuum or an inert gas atmosphere at a temperature of at least 1500° C. and removing a surface layer. The surface layer is preferably removed by the method of forming an oxide film under an oxidative atmosphere of at least 1000° C. and removing the surface of the formed oxide film with hydrofluoric acid or the like, the method of removing the same by polishing, or the method of removing the same by reactive ion etching, as hereinabove described.

Each of the semiconductor substrate and the powder consisting of the 6H—SiC single-crystalline phosphor doped with B and N can also be manufactured by such sublimation recrystallization that atmosphere gas in crystal growth contains N₂ gas of 1% to 30% in gas partial pressure and raw material SiC contains 0.05 mol % to 15 mol % of the B source. According to this mode, thermal annealing is preferably performed at a temperature of at least 1300° C. after sublimation recrystallization or thermal diffusion.

MB₂, BN, B₄C or LaB₆ is charged into a capsule of carbon and mixed into SiC powder containing N in a concentration of 10¹⁶/cm³ to 10¹⁷/cm³ as a B source, and the mixture is heated under a vacuum to a temperature of 1300° C. to 2000° C. in a crucible of carbon, and held for three hours to five hours. B is present on the surface of obtained SiC powder in a high concentration, and hence intense fluorescence can be observed when holding the SiC powder under an oxidative atmosphere at a temperature of 1000° C. to 1400° C. for two hours to four hours and thereafter removing an oxide film from the surface by chemical treatment with hydrofluoric acid, for example.

When BN is used as the B source, prescribed doping can also be performed by using a crucible of BN in place of the crucible of carbon, introducing raw material SiC powder into the crucible of BN and heating/baking the same. A method of preparing the raw material SiC powder is not restricted so far as the purity is at least 98%, and single-crystalline SiC may not necessarily be used.

According to such diffusion conditions, a layer emitting excellent fluorescence has a thickness of 1 μm to 4 μm from the surface, and hence the lower limit of the particle size of the SiC powder is 2 μm, preferably at least 2.5 μm. Since the thickness of the layer emitting excellent fluorescence is 1 μm to 4 μm from the surface and a part deeper than 4 μm from the surface weakens luminous intensity, the upper limit of the particle diameter of the SiC powder is 10 μm, preferably not more than 8 μm. For a similar reason, the central particle diameter is preferably 3 μm to 6 μm, more preferably 4 μm to 5 μm.

(Light-Emitting Diode)

A light-emitting diode according to the present invention comprises a semiconductor substrate consisting of a 6H—SiC single-crystalline phosphor doped with N and at least one of B and Al and a light-emitting device of a nitride semiconductor provided on the substrate.

A solid white light source can be implemented by mixing fluorescence emitted from the substrate of SiC excited by blue-violet light, utilized as excitation light, emitted from the nitride semiconductor provided on the substrate of SiC with the light from the nitride semiconductor. Further, it is possible to provide a light source excellent in color rendering with high color temperature reproducibility of white light without requiring a difficult mounting technique.

For example, a light-emitting diode having a GaN-based semiconductor emitting violet light of about 400 nm in wavelength on a substrate consisting of a 6H—SiC single-crystalline phosphor doped with B and N can obtain white light having high reproducibility and excellent color rendering through yellow fluorescence from SiC and violet light from the GaN semiconductor since the SiC substrate emits yellow fluorescence through the violet light from the GaN semiconductor serving as an excitation light source.

In a light-emitting diode having at least one or two layers consisting of a 6H—SiC single-crystalline phosphor doped with N and at least one of B and Al on a substrate of SiC for a semiconductor and comprising a light-emitting device of a nitride semiconductor on the 6H—SiC single-crystalline phosphor layer(s), at least one or two phosphor layers on the SiC substrate emit fluorescence in response to an added impurity with excitation light of blue or violet light from the nitride semiconductor, whereby an excellent solid white light source can be provided by mixing the fluorescence components with each other or mixing the light from the nitride semiconductor and the fluorescence with each other.

For example, a light-emitting diode prepared by forming a first SiC layer doped with Al and N on an n-SiC substrate doped with N and forming a second SiC layer doped with B and N on the first SiC layer with a GaN-based semiconductor emitting violet light of about 400 nm in wavelength provided on the second SiC can obtain white light having high reproducibility and excellent color rendering by utilizing yellow fluorescence and blue fluorescence from the SIC layers since the second SiC layer emits the yellow fluorescence and the first SiC layer emits the blue fluorescence with the violet light from the GaN-based semiconductor serving as an excitation light source.

An SiC substrate can be utilized as the phosphor according to the present invention for obtaining with light by employing a 6H-type single crystal as an SiC semiconductor substrate and doping the same with B, Al and N. On the other hand, excellent white light can be obtained by utilizing an SiC phosphor layer and a nitride semiconductor layer formed on a substrate without utilizing an SiC substrate as a phosphor. As to the doping concentration with at least one of B and Al and the doping concentration with N in the 6H—SiC single-crystalline phosphor in the light-emitting diode according to the present invention, both concentrations are preferably 10¹⁶/cm³ to 10¹⁹/cm³, more preferably 10¹⁷/cm³ to 10¹⁹/cm³, in order to increase luminous efficiency.

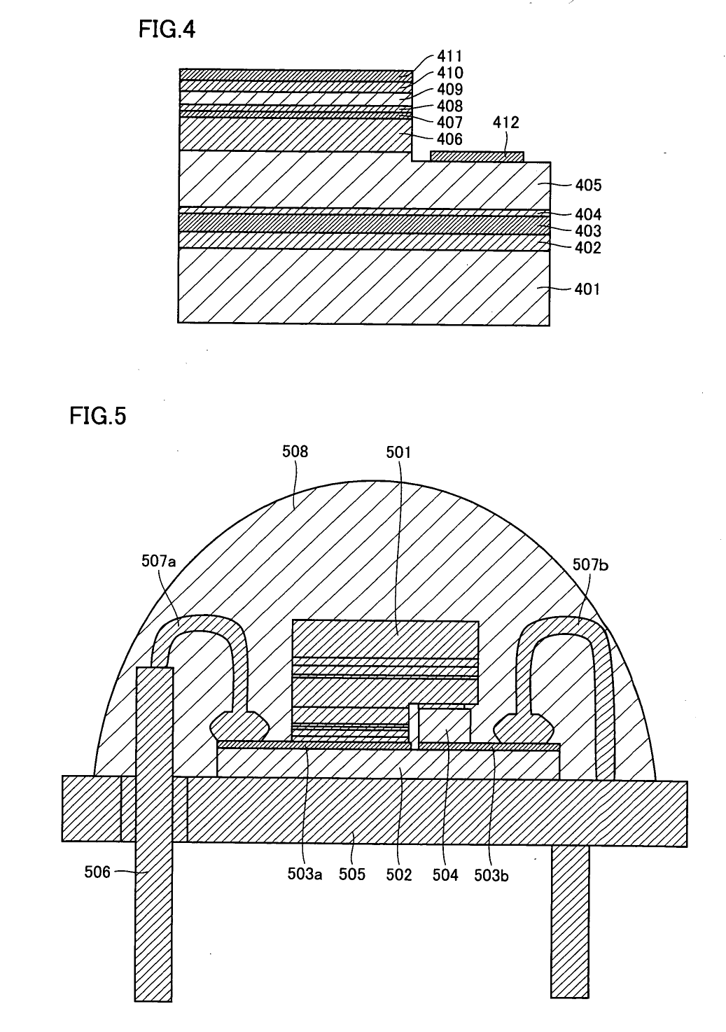

FIG. 4 illustrates one of typical structures of the light-emitting diode according to the present invention. In this example, a first impurity-added SiC layer 402 to which Al and N are added and a second impurity-added SiC layer 403 to which B and N are added are epitaxially grown on an SiC substrate 401 by CVD, for example. Further, an AlGaN buffer layer 404, an n-GaN first contact layer 405, an n-AlGaN first cladding layer 406, a GaInN/GaN multiple quantum well active layer 407, a p-AlGaN electron blocking layer 408, a p-AlGaN second cladding layer 409 and a p-GaN second contact layer 410 are formed on SiC layer 403 through epitaxial growth by metal organic compound vapor phase growth, for example. Then, a p electrode 411 of Ni/Au is formed on p-GaN second contact layer 410, etching is thereafter performed to expose n-GaN first contact layer 405 as shown in FIG. 4 and an n electrode 412 is formed on n-GaN first contact layer 405, thereby obtaining the light-emitting diode according to the present invention. In this example, a light-emitting device of a nitride semiconductor denotes each layer provided on second impurity-added SiC layer 403.

Excitation light from the nitride semiconductor is temporarily absorbed on absorption edges of SiC, and electron-hole pairs are relaxed to impurity levels. Therefore, the SiC layers doped with the impurities are preferably arranged between SiC substrate 401 and AlGaN buffer layer 404. While the nitride semiconductor can be properly selected from group III nitride semiconductors such as GaN, the semiconductor is preferably so selected that the emission wavelength in the light-emitting device serving as the excitation wavelength is not more than 408 nm which is the absorption edge wavelength of 6H—SiC.

The SiC layers to which Al, B and N are added can be formed by epitaxial growth or diffusion. For example, it is also possible to obtain a composite diode capable of controlling color rendering through a single process by locally diffusing B or Al into an SiC substrate to which N is added through a mask of sputtered carbon before epitaxially growing nitride semiconductors and partially separating a yellow part and a blue part from each other. A similar effect can be attained by simultaneously adding B, Al and N to a single layer, in place of the mode of forming at least two impurity-added layers.

### EXAMPLE 1

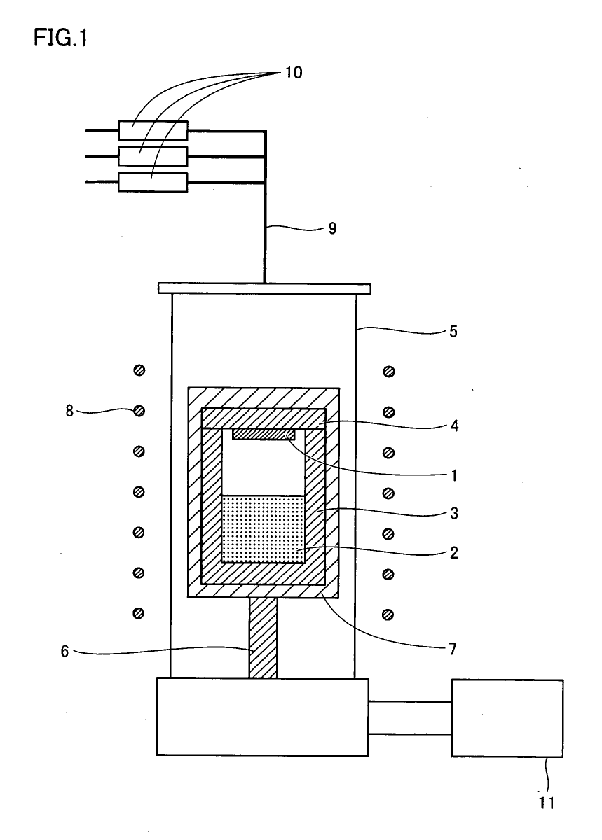

A phosphor of SiC was prepared by an improved Rayleigh method, as shown in FIG. 1. First, a substrate 1 of single-crystalline SiC serving as a seed crystal was mounted on the inner surface of a lid 4 of a graphite crucible 3. High-purity SiC (JIS particle size: #250) and a B source forming a raw material 2 were mixed with each other, and the mixture was thereafter charged into graphite crucible 3.

Then, graphite crucible 3 charged with raw material 2 was closed with lid 4 and set in a quartz tube 5 with a support rod 6 of graphite, so that the periphery of graphite crucible 3 was covered with a heat shield 7 of graphite. Ar gas and N₂ gas were fed into quartz tube 5 from an introduction tube 9 through a flowmeter 10 as atmosphere gas (flow rate of Ar gas: 1 liter/min). Then, a high-frequency current was fed to a work coil 8, and the temperatures of raw material 2 and substrate 1 were adjusted to reach 2300° C. and 2200° C. respectively.

Then, the flow rates of the Ar gas and the N₂ gas were controlled, and quartz tube 5 was decompressed with a vacuum pump 11. This decompression was gradually performed from the atmospheric pressure to 133 Pa for 20 minutes, and an SiC crystal of 55 mm in diameter and 10 mm in thickness was obtained by holding the pressure at 133 Pa for five hours.

The partial pressure of the N₂ gas in the atmosphere gas in crystal growth was set to 1%. Carbon impregnated with 5 mol % of simple B (metallic boron) was employed as a B source and mixed into the SiC powder so that simple B was 0.05 mol % with respect to the SiC powder, for preparing raw material powder.

The concentrations of B and N in the obtained SiC crystal measured with SIMS were 5×10¹⁷/cm³ and 3×10¹⁶/cm³ respectively. A crystal of 55 mm in diameter and 0.3 mm in thickness was cut out from the obtained SiC single crystal and a single face was polished for measuring fluorescence as to a flat surface. As a result of the measurement, the crystal emitted fluorescence having a wavelength of 500 nm to 750 nm with a peak wavelength of 620 nm, and presented a broad spectrum shown in FIG. 3.

As a result of holding the crystal after measurement at 1850° C. for four hours and performing thermal annealing, relative intensity of the light was improved to at least twice as compared with that before thermal annealing, while the shape of the spectrum remained substantially identical.

### EXAMPLE 2

An SiC crystal was manufactured similarly to Example 1, except that the partial pressure of N₂ gas in atmosphere gas in crystal growth was set to 5% and the concentration of simple B with respect to SiC powder was set to 0.5 mol %. The concentrations of N and B in the obtained SiC crystal were 3×10¹⁸/cm³ and 1×10¹⁷/cm³ respectively. While the shape of a fluorescence spectrum was similar to that of Example 1, relative intensity of light was improved to substantially three times as compared with the crystal before thermal annealing in Example 1.

### EXAMPLE 3

An SiC crystal was manufactured similarly to Example 1, except that the partial pressure of N₂ gas in atmosphere gas in crystal growth was set to 10% and the concentration of simple B with respect to SiC powder was set to 5 mol %. The concentrations of N and B in the obtained SiC crystal were 8×10¹⁸/cm³ and 5×10¹⁷/cm³ respectively. While the shape of a fluorescence spectrum was similar to that of Example 1, relative intensity of light was improved to substantially five times as compared with the crystal before thermal annealing in Example 1.

### EXAMPLE 4

An SiC crystal was manufactured similarly to Example 1, except that the partial pressure of N₂ gas in atmosphere gas in crystal growth was set to 30% and the concentration of simple B with respect to SiC powder was set to 15 mol %. The concentrations of N and B in the obtained SiC crystal were 1×10¹⁹/cm³ and 1×10¹⁸/cm³ respectively. While the shape of a fluorescence spectrum was similar to that of Example 1, relative intensity of light was reduced to substantially 1/10 as compared with the crystal before thermal annealing in Example 1.

From the results of Examples 1 to 4, it has been recognized that a phosphor of SiC having an N concentration of 5×10¹⁷/cm³ to 1×10¹⁹/cm³ and a B concentration of 3×10¹⁶/cm³ to 1×10¹⁸/cm³ is obtained by setting the partial pressure of N₂ gas in atmosphere gas in crystal growth to 1% to 30% and setting the concentration of simple B with respect to SiC powder to 0.05 mol % to 15 mol % and this phosphor emits fluorescence having a wavelength of 500 nm to 750 nm with a peak wavelength in the range of 500 nm to 650 nm.

### EXAMPLE 5

An SiC single crystal of 55 mm in diameter and 10 mm in thickness was obtained by the improved Rayleigh method similarly to Example 1 except that no B source was blended to raw material powder. A crystal of 55 mm in diameter and 0.3 mm in thickness was cut out from the obtained SiC single crystal similarly to Example 1, and a single face was polished. Then, 3 mol % of TaB₂, employed as a B source, with respect to SiC powder was mixed to the SiC powder, and the mixture was thereafter fixed to a holder. The aforementioned polished SiC crystal was mounted on this holder, and the interval between a flat surface of the SiC crystal and TaB₂ was prepared to be 0.1 mm.

Then, this holder was introduced into a crucible of carbon, heated to 1800° C. and held for four hours. When fluorescence was measured as to the obtained crystal, the crystal emitted fluorescence having a wavelength of 500 nm to 750 nm with a peak wavelength of 620 nm, and presented a broad spectrum shown in FIG. 3. When the concentrations of B and N in the obtained SiC crystal were measured with SIMS, the N concentration was 5×10¹⁷/cm³, and the B concentration was 5×10¹⁶/cm³ to 8×10¹⁸/cm³ respectively.

When thermal annealing was performed at 1800° C. for four hours, relative intensity of light was improved to twice while the shape of the fluorescence spectrum remained unchanged. When the surface of the crystal was scraped off by 2 μm through RIE, the shape of the fluorescence spectrum remained similar, while the relative intensity of the light was improved to 1.5 times as compared with that before scraping off the surface.

### EXAMPLE 6

The SiC single crystal obtained in Example 5 was pulverized in a mortar and classified for obtaining powder of 2 μm to 3 μm in particle size, and this powder was introduced into a crucible of a white BN sintered body and heated/baked. Baking was performed under an atmosphere of N₂ gas with decompression to 300 Pa, and the powder was held at 1800° C. for four hours. After the baking, the SiC powder was pulverized in a mortar and heated under an atmosphere (oxidative atmosphere) at 1200° C. for three hours for forming an oxide film on the surface. The obtained sintered body was treated with hydrofluoric acid of 70%, and powder was obtained by removing the surface by a thickness of about 1 μm and drying the sintered body.

When fluorescence was measured as to the obtained powder, the powder emitted fluorescence having a wavelength of 500 nm to 750 nm with a peak wavelength of 640 nm, and presented a broad spectrum similar to that of Example 5. When the concentrations of B and N in the obtained powder were measured with SIMS, the N concentration was 7×10¹⁷/cm³, and the B concentration was 9×10¹⁷/cm³ respectively.

### EXAMPLE 7

FIG. 4 shows the structure of a light-emitting diode according to this Example. A first impurity-added SiC layer 402 to which Al and N were added and a second impurity-added SiC layer 403 to which B and N were added were epitaxially grown by CVD, for example, and formed on an SiC substrate 401. Further, an AlGaN buffer layer 404, an n-GaN first contact layer 405, an n-AlGaN first cladding layer 406, a GaInN/GaN multiple quantum well active layer 407, a p-AlGaN electron blocking layer 408, a p-AlGaN second cladding layer 409 and a p-GaN second contact layer 410 were formed on SiC layer 403 by a metal organic compound vapor phase growth method, for example. Then, a p electrode 411 of Ni/Au was formed on p-GaN second contact layer 410, etching was performed to expose n-GaN first contact layer 405 as shown in FIG. 4, and an n electrode 412 was formed on n-GaN first contact layer 405, thereby obtaining the light-emitting diode.

Then, this light-emitting diode 501 was mounted on a stem 505, as shown in FIG. 5. This mounting was performed by an episide-down system on metal layers 503a and 503b of an insulating heat sink 502 formed on stem 505 through a gold bump 504. Thereafter metal layer 503a and a wiring lead 506 were connected with each other through a gold wire 507a, while another gold wire 507b was connected to metal layer 503b and fixed by epoxy resin 508.

When a voltage was applied to light-emitting diode 501 through gold wires 507a and 507b, a current was injected into the light-emitting diode. Consequently, GaInN/GaN multiple quantum well active layer 407 of FIG. 4 emitted violet light having a wavelength of 400 nm. In this violet light, a light component emitted toward SiC substrate 401 entered second impurity-added SiC layer 403 and first impurity-added SiC layer 402, to be substantially entirely absorbed by these layers while emitting fluorescence by impurity levels of the respective layers.

Second impurity-added SiC layer 403, to which B and N were added with concentrations of about 10¹⁸/cm³, emitted fluorescence having a spectrum such as that shown in FIG. 3 when excited with the violet light of 400 nm. This fluorescence, which was yellow fluorescence having a wavelength of 500 nm to 750 nm with a peak wavelength of about 600 nm as obvious from FIG. 3, also relatively largely included a red component exceeding 600 nm. The thickness of second impurity-added SiC layer 403 was 20 μm.

On the other hand, first impurity-added SiC layer 402, to which Al and N were added with concentrations of about 10¹⁸/cm³, emitted fluorescence having a spectrum such as that shown in FIG. 6 when excited with the violet light of 400 nm. This fluorescence was blue light having a wavelength of 400 nm to 750 nm with a peak wavelength of about 460 nm, as obvious from FIG. 6. The thickness of first impurity-added SiC layer 402 was 20 μm.

White light excellent in color rendering was obtained by mixing the fluorescence components from these two impurity-added SiC layers 402 and 403 with each other. It was possible to adjust the mixing ratio by varying the aforementioned doping concentrations and the thicknesses of SiC layers 402 and 403. This proved that the color temperature of white light is easy to control. The light-emitting diode generated the white light therein, whereby angle dependency of the tone of the emitted white light was negligibly small.

### EXAMPLE 8

FIG. 7 shows the structure of a light-emitting diode according to this Example. In this light-emitting diode, a first impurity-added SiC layer 702 to which Al and N were added and a second impurity-added SiC layer 703 to which B and N were added were epitaxially grown on an N-doped n-SiC substrate 701 by CVD, as shown in FIG. 7. Further, an n-AlGaN buffer layer 704, an n-GaN first contact layer 705, an n-AlGaN first cladding layer 706, a GaInN/GaN multiple quantum well active layer 707, a p-AlGaN electron blocking layer 708, a p-AlGaN second cladding layer 709 and a p-GaN second contact layer 710 were stacked on SiC layer 703 by a metal organic compound vapor phase growth method. Then, a p electrode 711 of Ni/Au was formed on the surface of p-GaN second contact layer 710 while an n electrode 712 was partially formed on the surface of SiC substrate 701, for obtaining the light-emitting diode.

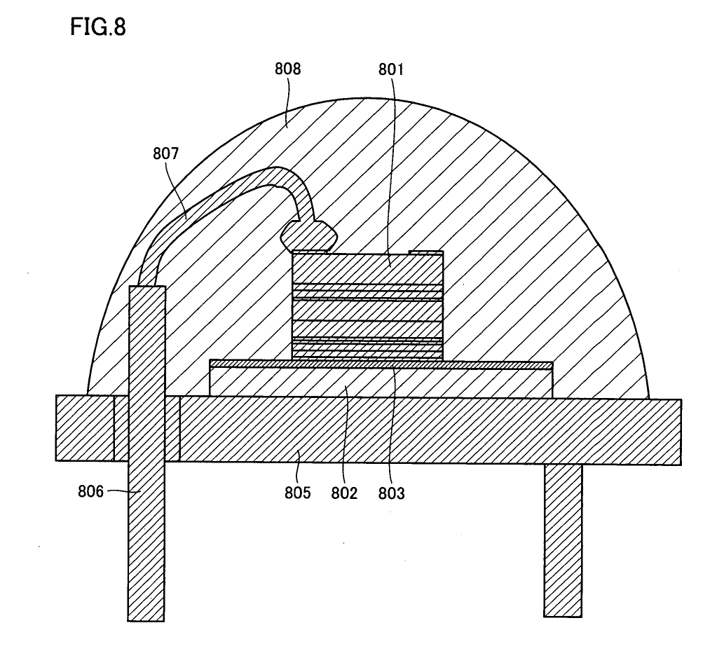

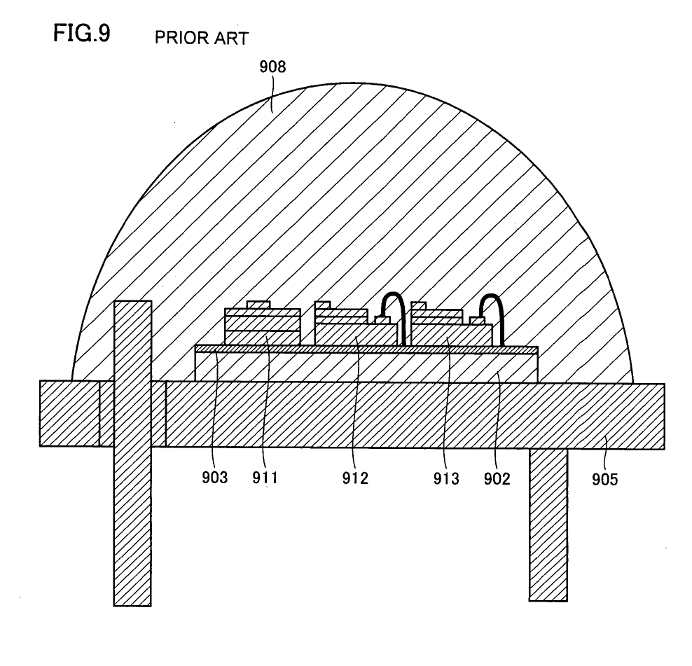

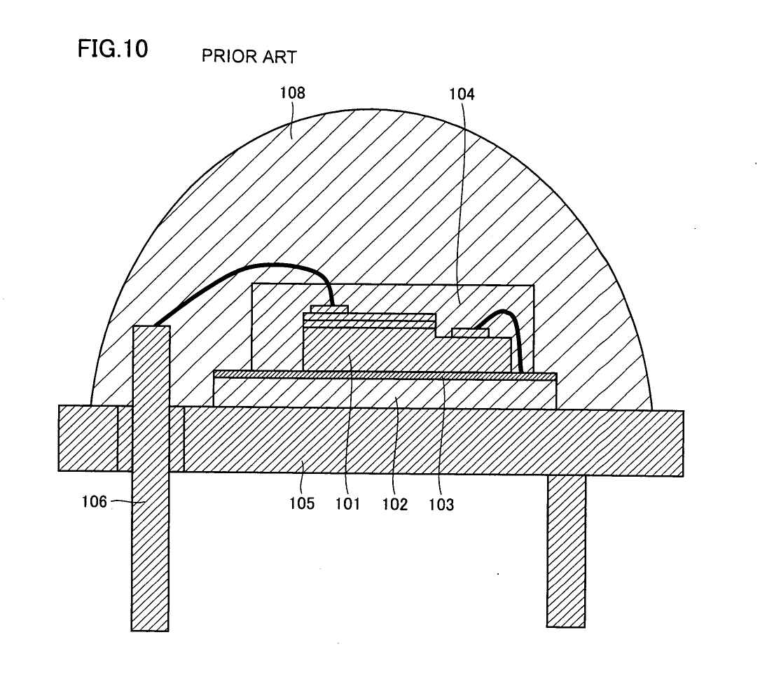

Then, this light-emitting diode 801 was mounted on a stem 805, as shown in FIG. 8. This mounting was performed by an episide-down system on a metal layer 803 of an insulating heat sink 802 formed on stem 805. Thereafter metal layer 803 and a wiring lead 806 were connected with each other through a gold wire 807, and fixed by epoxy resin 808.

When a voltage was applied to light-emitting diode 801, a current was injected into the light-emitting diode. Consequently, GaInN/GaN multiple quantum well active layer 707 of FIG. 7 emitted violet light having a wavelength of 400 nm. In this violet light, a light component emitted toward SiC substrate 701 entered second impurity-added SiC layer 703 and first impurity-added SiC layer 702, to be substantially entirely absorbed by these two layers while emitting fluorescence by impurity levels of the respective SiC layers.

Second impurity-added SiC layer 703, to which B and N were added with concentrations of about 10¹⁸/cm³, emitted fluorescence having a spectrum such as that shown in FIG. 3 when excited with the violet light of 400 nm. This fluorescence, which was yellow fluorescence having a wavelength of 500 nm to 750 nm with a peak wavelength of about 600 nm as obvious from FIG. 3, also relatively largely included a red component exceeding 600 nm. The thickness of second impurity-added SiC layer 703 was 30 μm.

On the other hand, first impurity-added SiC layer 702, to which Al and N were added with concentrations of about 10¹⁸/cm³, emitted fluorescence having a spectrum such as that shown in FIG. 6 when excited with the violet light of 400 nm. This fluorescence was blue light having a wavelength of 400 nm to 750 nm with a peak wavelength of about 460 nm, as obvious from FIG. 6. The thickness of first impurity-added SiC layer 702 was 30 μm.

White light excellent in color rendering was obtained by mixing the fluorescence components from these two impurity-added SiC layers 702 and 703 with each other. It was possible to adjust the mixing ratio by varying the concentrations of the doped impurities and the thicknesses of SiC layers 702 and 703. This proved that the color temperature of white light is easy to control. The light-emitting diode generated the white light therein, whereby angle dependency of the tone of the emitted white light was negligibly small.

### EXAMPLE 9

According to this Example, a conventional nitride semiconductor light-emitting diode having an emission wavelength of 440 nm to 480 nm and the inventive light-emitting diode were combined with each other to synthesize white light. The inventive light-emitting diode was prepared from a light-emitting diode emitting yellow fluorescence with excitation light prepared from violet light emitted from a nitride semiconductor.

The light-emitting diode was manufactured similarly to Example 8 except that no first impurity-added SiC layer doped with Al and N was formed but only a second impurity-added SiC layer doped with B and N was formed as an impurity-added SiC layer, and mounted similarly to Example 8, as shown in FIG. 8.

When a current was injected into the light-emitting diode, a GaInN/GaN multiple quantum well active layer emitted violet light of 400 nm in wavelength, and the violet light emitted toward an SiC substrate entered the impurity-added SiC layer to be substantially entirely absorbed by the impurity-added SiC layer while emitting fluorescence.

The impurity-added SiC layer, to which both B and N were added with concentrations of about 10¹⁸/cm³, emitted yellow fluorescence having a spectrum such as that shown in FIG. 3 when excited with the light of 400 nm. This yellow fluorescence had a wavelength of 500 nm to 750 nm with a peak wavelength of about 600 nm as obvious from FIG. 3, and also relatively largely included a red component exceeding 600 nm. The thickness of the impurity-added SiC layer was 30 μm.

It was possible to synthesize white light excellent in color rendering by combining this diode emitting yellow light with the conventional light-emitting diode (not shown) of a nitride semiconductor having an emission wavelength of 440 nm to 480 nm and mixing the light radiated from the diode emitting yellow light and the light radiated from the conventional diode with each other at a ratio of 3:1.

While a quaternary high-intensity diode of AlGaInP is put into practice as a diode emitting yellow light, it has been proved to be possible to easily obtain white light having high color rendering by combining the light-emitting diode manufactured in this Example, exhibiting a broad spectrum as shown in FIG. 3, with a blue light-emitting diode.

### EXAMPLE 10

An SiC crystal was grown similarly to Example 1, except that simple Al was mixed into SiC powder to be 0.1 mol % with respect to the SiC powder in place of the B source in crystal growth for preparing raw material powder. N and Al concentrations in the obtained SiC crystal were 5×10¹⁷/cm³ and 2×10¹⁶/cm³ respectively. Further, the SiC crystal emitted fluorescence having a wavelength of 400 nm to 750 nm with a peak wavelength of 430 nm and exhibited a broad spectrum such as that shown in FIG. 6.

When the crystal after measurement was held at 1850° C. for four hours and subjected to thermal annealing, relative intensity of the light was improved to at least twice as compared with that before thermal annealing, while the shape of the spectrum remained substantially identical.

### EXAMPLE 11

An SiC crystal was manufactured similarly to Example 10, except that the partial pressure of N₂ gas in atmosphere gas in crystal growth was set to 5% and the concentration of simple Al with respect to SiC powder was set to 1 mol %. N and Al concentrations in the obtained SiC crystal were 5×10¹⁸/cm³ and 1×10¹⁷/cm³ respectively. Relative intensity of light was improved to substantially twice as compared with the crystal before thermal annealing in Example 10, while the shape of a fluorescence spectrum was similar to that in Example 10.

### EXAMPLE 12

An SiC crystal was manufactured similarly to Example 10, except that the partial pressure of N₂ gas in atmosphere gas in crystal growth was set to 10% and the concentration of simple Al with respect to SiC powder was set to 10 mol %. N and Al concentrations in the obtained SiC crystal were 8×10¹⁸/cm³ and 4×10¹⁷/cm³ respectively. Relative intensity of light was improved to substantially three times as compared with the crystal before thermal annealing in Example 10, while the shape of a fluorescence spectrum was substantially identical to that in Example 10.

### EXAMPLE 13

An SiC crystal was manufactured similarly to Example 10, except that the partial pressure of N₂ gas in atmosphere gas in crystal growth was set to 30% and the concentration of simple Al with respect to SiC powder was set to 20 mol %. N and Al concentrations in the obtained SiC crystal were 1×10¹⁹/cm³ and 1×10¹⁸/cm³ respectively. Relative intensity of light was reduced to not more than substantially ⅓ as compared with the crystal before thermal annealing in Example 10, while the shape of a fluorescence spectrum was substantially identical to that in Example 10.

The embodiments and Examples disclosed this time must be considered as illustrative in all points and not restrictive. The range of the present invention is shown not by the above description but by the scope of claim for patent, and it is intended that all modifications within the meaning and range equivalent to the scope of claim for patent are included.

### INDUSTRIAL AVAILABILITY

The phosphor of SiC according to the present invention emits efficient fluorescence also when blue-violet light having a relatively long wavelength is employed as primary light, whereby a color mixture of excitation light and fluorescence can be obtained and a light-emitting diode using excitation light of a relatively long wavelength emitted from a semiconductor element or the like can be manufactured. This light-emitting diode is excellent in color rendering, at a low cost and useful as a white light source having high luminous efficiency. Further, SiC, which is a hardly altered material having high covalent bondability and conductivity, withstands an intense electron beam, and is also applicable to a discharge tube or a PDP.

1-23. (canceled)

24. A phosphor of SiC excited by an external light source for emitting light, doped with N and at least one of B and Al.

25. The phosphor of Sic according to claim 24, wherein
both of the doping concentration with at least one of B and Al and the doping concentration with N are 10¹⁵/cm³ to 10²⁰/cm³.

26. The phosphor of SiC according to claim 25, wherein
both of the doping concentration with at least one of B and Al and the doping concentration with N are 10¹⁶/cm³ to 10²⁰/cm³.

27. The phosphor of SiC according to claim 24, emitting fluorescence having a wavelength of 500 nm to 750 nm with a peak wavelength in the range of 500 nm to 650 nm.

28. The phosphor of SiC according to claim 27, wherein
SiC is doped with N and B, the concentration of either N or B is 10¹⁵/cm³ to 10¹⁸/cm³, and the concentration of either B or N is 10¹⁶/cm³ to 10¹⁹/cm³.

29. The phosphor of SiC according to claim 24, emitting fluorescence having a wavelength of 400 nm to 750 nm with a peak wavelength in the range of 400 nm to 550 nm.

30. The phosphor of SiC according to claim 29, wherein
SiC is doped with N and Al, the concentration of either N or Al is 10¹⁵/cm³ to 10¹⁸/cm³, and the concentration of either Al or N is 10¹⁶/cm³ to 10¹⁹/cm³.

31. A method of manufacturing a phosphor of SiC excited by an external light source for emitting fluorescence having a wavelength of 500 nm to 750 nm with a peak wavelength in the range of 500 nm to 650 nm and doped with N and B so that the concentration of either N or B is 10¹⁵/cm³ to 10¹⁸/cm³ and the concentration of either B or N is 10¹⁶/cm³ to 10¹⁹/cm³,
by forming an SiC crystal by sublimation recrystallization with a B source of LaB₆, B₄C, TaB₂, NbB₂, ZrB₂, HfB₂, BN or carbon containing B.

32. The method of manufacturing a phosphor of SiC according to claim 31, performing thermal annealing at a temperature of at least 1300° C. for at least one hour after sublimation recrystallization or thermal diffusion.

33. A method of manufacturing a phosphor of SiC excited by an external light source for emitting fluorescence having a wavelength of 500 nm to 750 nm with a peak wavelength in the range of 500 nm to 650 nm and doped with N and B so that the concentration of either N or B is 10¹⁵/cm³ to 10¹⁸/cm³ and the concentration of either B or N is 10¹⁶/cm³ to 10¹⁹/cm³,
by thermally diffusing a B source of simple B, LaB₆, B₄C, TaB₂, NbB₂, ZrB₂, HfB₂ or BN into SiC under a vacuum or an inert gas atmosphere at a temperature of at least 1500° C.

34. The method of manufacturing a phosphor of SiC according to claim 33, performing thermal annealing at a temperature of at least 1300° C. for at least one hour after sublimation recrystallization or thermal diffusion.

35. The method of manufacturing a phosphor of SiC according to claim 33, removing a surface layer after thermal diffusion.

36. A substrate for a semiconductor consisting of a 6H—SiC single-crystalline phosphor excited by an external light source for emitting light and doped with N and at least one of B and Al.

37. The substrate for a semiconductor according to claim 36, consisting of a 6H—SiC single-crystalline phosphor doped with N and B for emitting fluorescence having a wavelength of 500 nm to 750 nm with a peak wavelength in the range of 500 nm to 650 nm.

38. The substrate for a semiconductor according to claim 36, consisting of a 6H—SiC single-crystalline phosphor doped with N and Al for emitting fluorescence having a wavelength of 400 nm to 750 nm with a peak wavelength in the range of 400 nm to 550 nm.

39. A method of manufacturing a substrate for a semiconductor consisting of a 6H—SiC single-crystalline phosphor excited by an external light source for emitting fluorescence having a wavelength of 500 nm to 750 nm with a peak wavelength in the range of 500 nm to 650 nm and doped with N and B so that the concentration of either N or B is 10¹⁵/cm³ to 10¹⁸/cm³ and the concentration of either B or N is 10¹⁶/cm³ to 10¹⁹/cm³, comprising the steps of:
thermally diffusing a B source of simple B, LaB₆, B₄C, TaB₂, NbB₂, ZrB₂, HfB₂ or BN into SiC under a vacuum or an inert gas atmosphere at a temperature of at least 1500° C.; and
removing a surface layer.

40. The method of manufacturing a substrate for a semiconductor according to claim 39, performing thermal annealing at a temperature of at least 1300° C. after sublimation recrystallization or thermal diffusion.

41. A method of manufacturing a substrate for a semiconductor consisting of a 6H—SiC single-crystalline phosphor excited by an external light source for emitting fluorescence having a wavelength of 500 nm to 750 nm with a peak wavelength in the range of 500 nm to 650 nm and doped with N and B so that the concentration of either N or B is 10¹⁵/cm³ to 10¹⁸/cm³ and the concentration of either B or N is 10¹⁶/cm³ to 10¹⁹/cm³, wherein
atmosphere gas in crystal growth contains N₂ gas of 1% to 30% in gas partial pressure, and raw material SiC contains 0.05 mol % to 15 mol % of a B source, and an SiC crystal is formed by sublimation recrystallization.

42. The method of manufacturing a substrate for a semiconductor according to claim 41, performing thermal annealing at a temperature of at least 1300° C. after sublimation recrystallization or thermal diffusion.

43. Powder for a semiconductor consisting of a 6H—SiC single-crystalline phosphor excited by an external light source for emitting fluorescence having a wavelength of 500 nm to 750 nm with a peak wavelength in the range of 500 nm to 650 nm, having a particle diameter of 2 μm to 10 μm and a central particle diameter of 3 μm to 6 μm.

44. A light-emitting diode comprising a substrate for a semiconductor consisting of a 6H—SiC single-crystalline phosphor doped with N and at least one of B and Al and a light-emitting device of a nitride semiconductor formed on said substrate.

45. The light-emitting diode according to claim 44, wherein
the emission wavelength of said light-emitting device of a nitride semiconductor is not more than 408 nm.

46. The light-emitting diode according to claim 44, wherein
both of the doping concentration with at least one of B and Al and the doping concentration with N in said 6H—SiC single-crystalline phosphor are 10¹⁶/cm³ to 10¹⁹/cm³.

47. The light-emitting diode according to claim 46, wherein both of the doping concentration with at least one of B and Al and the doping concentration with N in said 6H—SiC single-crystalline phosphor are 10¹⁷/cm³ to 10¹⁹/cm³.

48. A light-emitting diode having one or at least two layers consisting of a 6H—SiC single-crystalline phosphor doped with N and at least one of B and Al on a substrate of SiC for a semiconductor and comprising a light-emitting device of a nitride semiconductor on said 6H—SiC single-crystalline phosphor layer(s).

49. The light-emitting diode according to claim 48, wherein
the emission wavelength of said light-emitting device of a nitride semiconductor is not more than 408 nm.

50. The light-emitting diode according to claim 48, wherein
both of the doping concentration with at least one of B and Al and the doping concentration with N in said 6H—SiC single-crystalline phosphor are 10¹⁶/cm³ to 10¹⁹/cm³.

51. The light-emitting diode according to claim 50, wherein
both of the doping concentration with at least one of B and Al and the doping concentration with N in said 6H—SiC single-crystalline phosphor are 10¹⁷/cm³ to 10¹⁹/cm³.
